(19) United States
(12) Patent Application Publication
(10) Pub. No.: US 2007/0271917 A1
(43) Pub. Date: Nov. 29, 2007

(54) Actuating Element For A Supercharger In Combustion Engines

(76) Inventor: Guenther Vogt, Holzkirchen (DE)

Correspondence Address: KENYON & KENYON LLP, ONE BROADWAY, NEW YORK, NY, 10004, US

(21) Appl. No.: 10/588,090

(22) PCT Filed: Jan. 4, 2005
(86) PCT No.: PCT/EP05/50013

§ 371 Date: Jun. 8, 2007

(30) Foreign Application Priority Data
Jan. 30, 2004 (DE) 10 2004 005 001.5

(51) Int. Cl. F02B 37/12

(52) U.S. Cl. 60/600

(57) ABSTRACT

In a device for operating a first control element for controlling gaseous media, a transmission element is formed on a final controlling element manipulatable by an actuator, the transmission element being able to be moved, on one hand, inside a slot of a slotted lever and being, the other hand, stationary-mounted to a supporting lever, which is attached to a stationary support at a joint location. The first control element is accommodated on the slotted lever, which is manipulatable via the transmission element, the control element being movable between a closed position and an open position in response to manipulation of the final controlling element by the actuator.

### FIELD OF THE INVENTION

The present invention relates to an actuating element for actuating a control element for a supercharges in a combustion engine.

### BACKGROUND INFORMATION

Supercharging methods are used in combustion engines, in order to increase the engine power, which is directly proportional to the rate of air flow. In addition to the dynamic boost that utilizes the dynamics of the air drawn in, the mechanical boost is used, where the supercharging device is driven directly by the engine. In this context, the combustion engine and the supercharging device mostly have a fixed transmission ratio with respect to each other. In the scope of the mechanical supercharging, exhaust-gas turbochargers are used in which the energy of the exhaust gas is used for driving the supercharger. On one hand, the energy, which, in the case of induction engines, cannot be utilized due to the expansion ratio predetermined by the crankshaft drive, is utilized, and on the other hand, the exhaust gas is accumulated to a higher degree upon leaving the engine, in order to obtain the necessary compressor power. Supercharging controlled in two stages is used within the scope of the exhaust-gas turbochargers, where two exhaust-gas turbochargers of different sizes are connected in series.

A supercharging method employing two-stage control is known from the “Automotive Handbook,” Bosch (Chief Editor Horst Bauer, 23rd updated and expanded edition, Braunschweig; Wiesbaden: Vieweg 1999, ISBN 3-528-08376-4, pages 445, 466). According to this supercharging method, which can be used in motor vehicles, the two-stage-controlled supercharging is implemented by a series connection of two differently sized exhaust-gas turbochargers, along with a bypass control unit and an intercooler.

The mass flow of exhaust gas coming from the cylinders of the internal combustion engine initially flows into an exhaust-gas manifold. From here on, there is the option of either expanding the entire mass flow of exhaust gas through a high-pressure turbine or rerouting a part of the mass flow through the bypass line. The entire mass flow of exhaust gas is then utilized once more by the post-connected, low-pressure turbine. The entire mass flow of fresh air is initially precompressed by the low-pressure stage and ideally intercooled. Further compression and intercooling subsequently occurs in the high-pressure stage. Due to the precompression, the relatively small high-pressure compressor operates at a higher pressure, so that it can push through the necessary mass flow of air.

In the case of lower engine speeds, i.e., when the mass flow rate of exhaust gas is small, the bypass remains completely closed, and the entire mass flow of exhaust gas expands via the high-pressure turbine. This produces a very rapid and high supercharging pressure. As the speed of the engine increases, the expansion work is continuously shifted to the low-pressure turbine by increasing the cross-sectional area of the bypass accordingly. Consequently, the two-stage-controlled supercharging of an internal combustion engine allows the side of the turbines and the compressor(s) to be continuously adjusted to the requirements of the engine operation.

In order to divert the mass flow of exhaust gas in the supercharging method occurring in two stages, as outlined above, flaps suspended on one side may be used, as are known from waste-gate turbochargers.

The suspended flaps allow low production costs, since the manufacturing is optimized to the greatest possible extent. In general, a suspended flap is activated by a pneumatic control capsule, which is directly coupled to a lever on the outside of the housing of the exhaust gas turbocharger. In the case of a fixed control-capsule path, the constant lever arm allows a fixed angular range to be swept over. High actuating forces may be produced upon closing the suspended flap, since the flap is moved in the opening direction by the applied exhaust-gas pressure. This means that on one hand, either large forces must be applied to the control capsule or, on the other hand, high actuating travel must be provided, in order to thus apply a large lever arm to the flap shaft. Both mean high control volumes and, consequently, limited actuating speeds and high follow-up costs from any safety reserves lying idle. In addition, the installation conditions are unfavorable in most cases, since the prevailing developmental tendency in the automotive field is for the available space in the engine compartment to become smaller and smaller.

The vacuum system of a motor vehicle must also keep the necessary volumes ready, without safety-related functions, such as a power-brake unit, being affected by this.

### SUMMARY

In the present invention, the holder receiving the control capsule, and a base plate, are welded to each other and receive the control capsule. A slotted lever is mounted to the shaft actuating a control element. With the aid of a joint head, a connection to the piston rod is produced, which moves into and out of the control capsule. A guide pin moves in a slotted hole of the slotted lever and is guided by a supporting lever, whose outer support is fixed to the base plate by the support bolt. The forces are transmitted to the slotted lever via the guide sleeve, which is designed to be able to roll.

The lever arm is lengthened or shortened with respect to the flap-shaped control element, by sliding the guide bolt on the slotted lever. Consequently, it is possible to transmit different torques to the control element as a function of position. In a first position, the opening movement of the control element is inhibited by the lateral forces absorbed by the supporting lever. The opening movement may be unintentionally caused by disruptive forces acting upon the control element. In the event of high pressures applied to the closed control element, the design approach of the present invention already prevents it from opening unintentionally by producing low actuating forces.

In a further position, a large adjustment angle may be produced via a small lever arm on the flap shaft. This allows a large opening angle of the control element to be attained in ranges where only small changes in the flow resistance occur with respect to the flap angle.

Because of the low friction that occurs in the rolling movement of the provided design approach, the hysteresis of the provided system is extremely small.

The considerably reduced actuating forces provided by the design approach of the present invention allow a pneumatic control capsule, as is presently used, to be replaced by an alternative actuator, such as an electric actuator.

### BRIEF DESCRIPTION OF THE DRAWINGS

FIG. 1 shows a partially sectioned view of an exhaust-gas turbocharger having a turbine part and a compressor part.

FIG. 2 shows the kinematics of the activation of a control element, the control element being adjusted into a closed position.

FIG. 3 shows the kinematics described in FIG. 2, in an open position of the control element.

FIG. 4 shows, in a front view, the kinematics for actuating the control element according to FIGS. 2 and 3.

### DETAILED DESCRIPTION

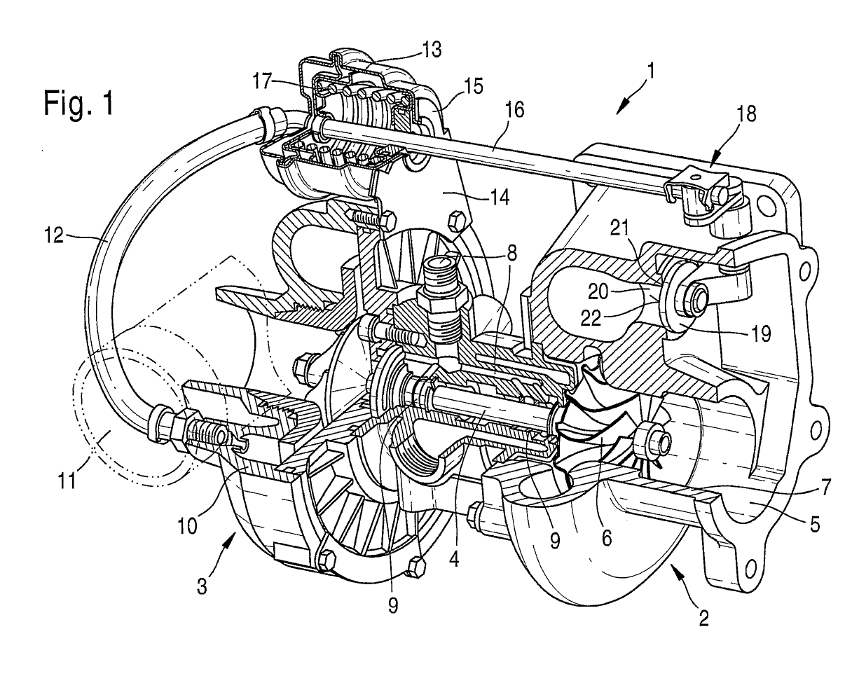

A partially sectioned view of an exhaust-gas turbocharger is shown in FIG. 1.

Exhaust gas turbocharger 1 represented in FIG. 1 includes a turbine part 2 and a compressor part 3. Exhaust-gas turbocharger 1 represented in FIG. 1 may be used, for example, in internal combustion engines of automobiles and commercial vehicles, or in other combustion engines. A turbine wheel 6 is acted upon by exhaust gas via an exhaust-gas inlet 5, and is set into rotation by the exhaust gas. Turbine wheel 6 is seated in a rotatably fixed manner on an exhaust-gas turbocharger shaft 4, on which a compressor impeller is accommodated. Turbine wheel 6 is accommodated by a turbine housing 7, in which a bypass line 20 is formed. Bypass line 20 may be unblocked or closed by a control element 19, which is formed in the shape of a flap in the representation of FIG. 1. When a combustion engine is supercharged in multiple stages, a partial stream of the exhaust gas may be fed via bypass line 20 to a further exhaust-gas turbocharger, which is not shown in the representation according to FIG. 1. In order to control the partial exhaust-gas stream fed to the additional exhaust-gas turbocharger, control element 19 is actuated with the aid of a control capsule 13 positioned on exhaust-gas turbocharger 1.

Turbine housing 7 of exhaust-gas turbocharger 1 is connected to a compressor housing 10. Exhaust-gas turbocharger shaft 4, which is assigned a lubricant supply 8 in order to ensure low-friction running of exhaust-gas turbocharger shaft 4 during operation of exhaust-gas turbocharger 1, extends through the two housings 7 and 10. Shaft bearings 9, which are preferably friction bearings, are provided with lubricant by lubricant supply 8, so that a lubricant film forms on shaft bearings 9, between the surface of exhaust-gas turbocharger shaft 4 and the bearings. Air is compressed and fed to a charge-air outlet 11 by the compressor impeller, which is positioned on exhaust-gas turbocharger shaft 4 and is set into rotation by the impingement of the exhaust gas upon turbine wheel 6. The precompressed charge air is fed to the induction tract of a combustion engine, not shown here, to improve the cylinder charging.

A branch 12 is provided at compressor housing 10 of exhaust-gas turbocharger 1. Pressure above atmospheric may be applied to control capsule 13 shown in FIG. 1, via branch 12, which means that control element 19 may be actuated via a control capsule 13, to which pressure above atmospheric has been applied. In addition, control capsule 13 shown in FIG. 1 may also be actuated via application of negative pressure, which is provided, for example, in motor vehicles having self-igniting combustion engines.

Compressor housing 10 of exhaust-gas turbocharger 1 communicates with control capsule 13 via branch 12, the control capsule being flange-mounted to the exhaust-gas turbocharger branch. Control capsule 13 is attached to compressor housing 10 via a flange 15. A spring element 17, which takes the form of a helical spring in the representation of FIG. 1, is situated inside the housing of control capsule 13. A piston rod 16 is moved in a straight line by applying positive/negative pressure to control capsule 13.

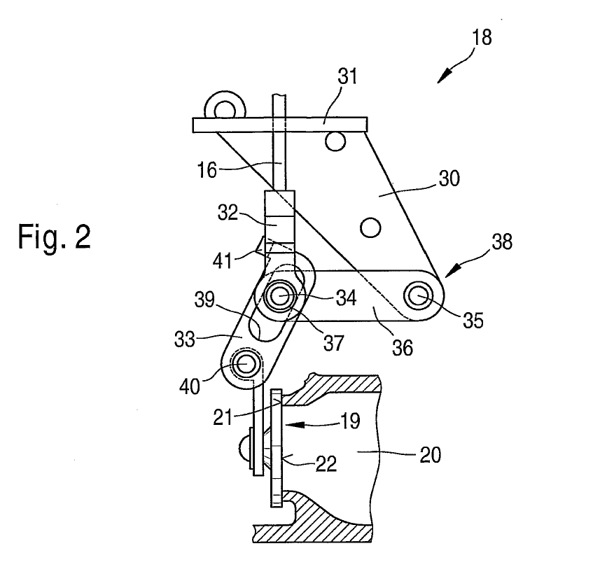

A baffle 18 is actuated by piston rod 16. Baffle 18 includes a compound-lever system, which is described in detail in FIGS. 2, 3, and 4, and with the aid of which control element 19, which may be formed in the shape of a flap, may be adjusted into an open position or a closed position or an operationally dependent, intermediate position.

Control element 19 according to the representation in FIG. 1 takes the form of an axially symmetric, circular flap and, in the closed state, rests against a contact surface 21 on the end face of bypass line 20, in turbine part 2 of exhaust-gas turbocharger 1. In the closed position, bypass line 20 for admitting exhaust gas of the combustion engine into a further exhaust-gas turbocharger, is closed. Flap surface 22 of control element 19 formed in the shape of a flap is dimensioned in such a manner that bypass line 20 is completely closed with respect to a further exhaust-gas turbocharger when control element 19 rests against contact surface 21. On the basis of the volumetric flow rate of exhaust gas prevailing in bypass duct 20 of exhaust-gas turbocharger 1, the closed position of control element 19 formable in the shape of a flap is implemented by the spring force of spring 17 accommodated in control capsule 13, in order to prevent a partial exhaust-gas stream from unintentionally overflowing through bypass channel 20 into the further exhaust-gas turbocharger not shown in FIG. 1. According to the view shown in FIG. 1, piston rod 16 extends from control capsule 13, which is accommodated on compressor part 3 of exhaust-gas turbocharger 1, in parallel to exhaust-gas turbocharger shaft 4, to turbine part 2 of exhaust-gas turbocharger 1.

Shown in FIG. 2 is the actuating device for the control element, in a first actuating position.

Control capsule 13, by which piston rod 16 is manipulated, is not shown in further detail in the representation according FIG. 2. Piston rod 16 reaches through an opening in a base plate 31 and has a joint head 32 on its end pointing towards control element 19. Joint head 32 may be screwed, for example, onto a threaded segment of piston rod 16. A base plate 30 is welded to control-capsule holder 31 or 15. Base plate 30 includes a first joint 38, to which a supporting lever 36 is linked. For this purpose, a support bolt 35 is provided at first joint 38, the support bolt allowing supporting lever 36 to swivel relative to base plate 30.

A guide pin 34 is supported on supporting lever 36, at the end opposite to first joint 38. On one hand, guide pin 34 is accommodated on joint head 32, and on the other hand, it passes through a slot 39 in slotted lever 33, the slot preferably taking the form of a slotted hole. Guide pin 34 includes a guide sleeve 37, which is received at guide pin 34 so as to be able to rotate. Guide sleeve 37 roles at its circumferential surface on the inside of slot 39 in slotted lever 33. Situated at one end of slotted lever 33 is a flap bearing 40, to which control element 19 taking the form of, e.g., a circular control flap is attached. Also accommodated on slotted lever 33 is a path limiter 41, which, in the position of slotted lever 33 according to the representation in FIG. 2, is run over joint head 32. Slotted lever 33 partially passes through the wall of bypass line 20. With the aid of guide sleeve 37, which is supported on guide pin 34 and positioned so as to be able to rotate, the actuating forces of piston rod 16 are transmitted to slotted lever 33 and therefore to control element 19, for opening and closing bypass line 20 in turbine part 2 of exhaust-gas turbocharger 1 according to the representation in FIG. 1.

In the view according to FIG. 2, supporting lever 36 is parallel to control-capsule holder 31. The guide pin 34 movable in slot 39, together with guide sleeve 37, is adjusted up with respect to the longitudinal extension of slot 39, whereby control element 19 rests against contact service 21 of bypass line 20 in turbine part 2 of exhaust-gas turbocharger 1 and consequently closes bypass line 20.

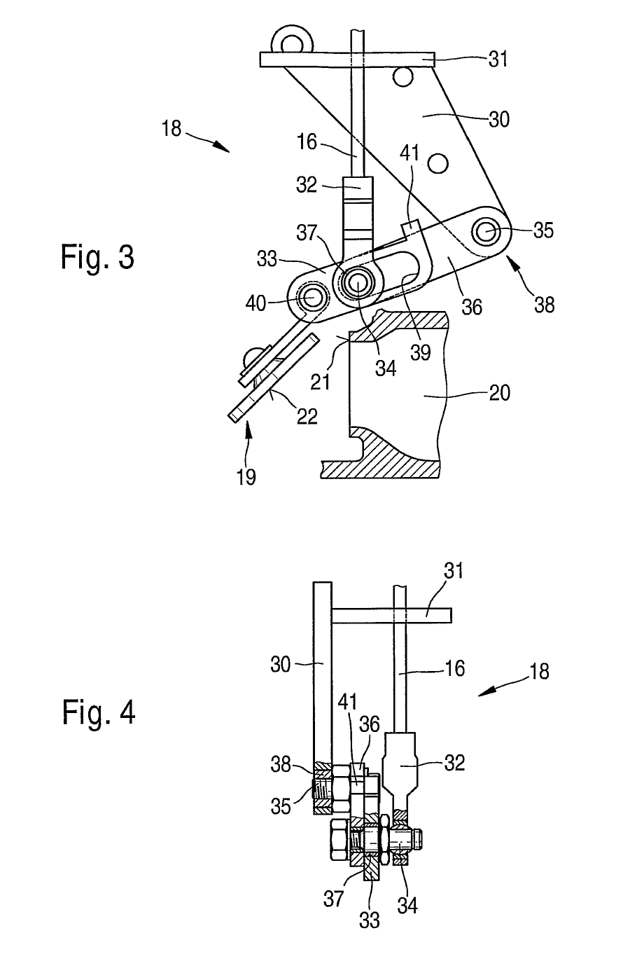

The kinematics of the actuating device can be gathered from the representation according to FIG. 3, the control element actuated by the actuating device being moved into its open position.

In contrast to the representation according FIG. 2, piston rod 16 is moved out of control capsule 13 which is not shown in FIG. 3 (cf. representation according FIG. 1). Therefore, joint head 32, which is connected to piston rod 16, is extended out in the direction of bypass line 20. While piston rod 16 is moved out of control capsule 13, the coupling of guide pin 34 to joint head 32 causes guide sleeve 37 accommodated on guide pin 34, together with guide pin 34, to be moved inside of slot 39 of slotted lever 33. Since guide pin 34 is also mounted on supporting lever 36, the extension movement of piston rod 16 out of control capsule 13 in the vertical direction of bypass channel 20 impresses a clockwise swiveling motion in slotted lever 33. As shown in FIG. 3, the swivel motion of slotted lever 33 is limited by the contact of path limiter 41 with a lateral surface of supporting lever 36. During the clockwise swiveling movement of slotted lever 33, control element 19 taking the form of a control flap is also rotated clockwise about guide pin 34 and assumes its open position represented in FIG. 3. In the position of circularly formable control element 19 shown in FIG. 3, the outlet cross section of bypass line 20 is unblocked by control element 19. A partial exhaust-gas stream or another gaseous medium is now able to flow through uncovered bypass duct 20 and, e.g., to flow into a further exhaust-gas turbocharger downstream from the one in FIG. 1. In the open position of control element 19 formed in the shape of a circle, it follows from the representation of FIG. 3 that slot 39 assumes a nearly horizontal position. At first joint 38, supporting lever 36 is inclined about supporting bolt 35, out of its position parallel to control-capsule holder 31.

The positioning travel with respect to the swiveling path of control element 19 formed in the shape of a circle may be influenced, for example, by adjusting joint head 32 on the end segment of piston rod 16 that moves out of control capsule 13. This allows the open and closed positions of circular control element 19 to be adjusted, and allows the positioning path traveled by circularly formable control element 19 from its closed position (cf. view according to FIG. 2) to its open position (cf. view according to FIG. 3) to be finely adjusted.

It can be deduced from the view according to FIG. 4 that joint head 32 has a shell-shaped bearing body for receiving guide pin 34. In the region of slot 39, guide sleeve 37 is accommodated on guide pin 34 so as to be rotatable. Guide pin 34 also passes through supporting lever 36 and may be fastened to it, for example, by a threaded member or the like. At its circumferential surface, guide sleeve 37 rotatably accommodated on guide pin 34 rolls on the inside of slot 39 and forces slotted lever 33, for its part, to swivel clockwise from the closed position of control element 19 according to the view in FIG. 2, into its open position (cf. view according to FIG. 3). Supporting lever 36 is also mounted on base plate 30 via supporting bolt 35, it being ensured that supporting lever 36 can swivel relative to supporting bolt 35 of first joint 38, by inserting a bearing shell. For the sake of completeness, it should be mentioned that the support for control element 19 is attached to the lower end of slotted lever 33 (cf. reference numeral 40).

Using actuating device 18 described in detail in connection with FIGS. 2, 3, and 4, the lever arm with respect to control element 19 may be lengthened or shortened by moving guide pin 34 inside slot 39 of slotted lever 33. This allows different torques to be transmitted to control element 19 as a function of the position of slotted lever 33. In the position shown in FIG. 2, the absorption of lateral forces by supporting lever 36 inhibits the opening movement of control element 19, which may be designed, for example, as a circular flap; the opening movement being able to be caused unintentionally by disruptive forces on control element 19. When the occurring pressure of the gaseous medium to be controlled is high, e.g., in the case of pressure fluctuations that can bring about the opening of control element 19 in its closed state, this situation may be counteracted by relatively small actuating forces.

In the case of the position of control element 19 shown in FIG. 3, a large adjusting angle of control element 19 is achieved by a small lever arm with respect to flap shaft 40. This allows large opening angles of control element 19 formed in the shape of a flap to be attained in ranges, in which only small changes in the flow resistance occur in relation to the opening angle of control element 19. Due to the low friction during the rolling movement of guide sleeve 37 inside slot 39 formed within slotted lever 33, the hysteresis of the actuating device provided by the present invention is very small. Due to the relatively small actuating forces for actuating baffle 18, a pneumatic control capsule 13, e.g., one operated by the action of negative pressure, may also be replaced by an alternative actuator, such as an electric actuator. This eliminates the need for a negative-pressure consumer, which means that all of the negative pressure is available to a safety-related system in the motor vehicle, such as the power-break unit, and that no negative pressure would have to be diverted for operating control capsule 13 of an exhaust-gas turbocharger 1.

The very compact baffle 18 according to the representation in FIGS. 2, 3, and 4 eliminates long actuating paths, which take up space and negatively affect the actuating speeds. The design of baffle 18 provided by the present invention allows high forces to be applied, which reliably hold the control element 19 able to take the form of, e.g., a flap, in its closed position, i.e., resting against contact surface 21 of bypass line 20, which means that control element 19 formed in the shape of a flap is reliably prevented from opening unintentionally.

1-9. (canceled)

10. A device for controlling a bypass line of a supercharger in a combustion engine, comprising:
a flow-control element which has a surface for selectively opening and closing the bypass line conveying a gaseous medium;
a control assembly for controlling the selective movement of the flow-control element, wherein the control assembly includes: a) an actuator for providing an actuating motion, the actuator having a transmission element; b) a support element guiding the transmission element, wherein the support element is configured to swivel about a joint position; and c) a slotted lever connected to the transmission element and the flow-control element, the transmission element causing the slotted lever to swivel in order to actuate the flow-control element.

11. The device as recited in claim 10, further comprising:
a guide sleeve rotatably positioned on the transmission element.

12. The device as recited in claim 11, wherein the guide sleeve is configured to roll in a slot of the slotted lever.

13. The device as recited in claim 10, wherein the flow-control element is stationary-mounted to the slotted lever.

14. The device as recited in claim 10, wherein the actuator includes a rod, and when the rod is moved, the transmission element that is guided by the support element correspondingly moves the slotted lever to achieve one of a closed position and an open position of the flow-control element.

15. The device as recited in claim 10, wherein a path limiter is provided on the slotted lever, the path limiter limiting the maximum swiveling movement of the slotted lever about the transmission element.

16. The device as recited in claim 10, wherein the actuator includes a rod, and wherein the rod includes a joint head having a bearing shell for receiving the transmission element.

17. The device as recited in claim 10, wherein the actuator is an electromotively powered actuator.

18. The device as recited in claim 10, wherein the actuator is an electromagnetically operated actuator.
